(19) United States
(12) Patent Application Publication
(10) Pub. No.: US 2024/0346309 A1
(43) Pub. Date: Oct. 17, 2024

(54) HETEROGENEOUS GRAPH NEURAL NETWORK USING OFFSET TEMPORAL LEARNING FOR SEARCH PERSONALIZATION

(71) Applicant: Roku, Inc., San Jose, CA (US)

(72) Inventors: Abhishek Majumdar, Santa Clara, CA (US); Kapil Kumar, London (GB); Nitish Aggarwal, Sunnyvale, CA (US); Srimaruti Manoj Nimmagadda, Saratoga, CA (US)

(73) Assignee: Roku, Inc., San Jose, CA (US)

(21) Appl. No.: 18/582,249

(22) Filed: Feb. 20, 2024

Related U.S. Application Data
(60) Provisional application No. 63/459,539, filed on Apr. 14, 2023.

(51) Int. Cl. G06N 3/08; G06N 3/042

(52) U.S. Cl. CPC G06N 3/08; G06N 3/042

(57) ABSTRACT

Disclosed herein are system, apparatus, article of manufacture, method and/or computer program product embodiments, and/or combinations and sub-combinations thereof, for training a heterogenous graph neural network (GNN) to generate user embeddings corresponding to users and item embeddings corresponding to items. An example embodiment generates a first user interaction graph for a first time window and a second user interaction graph for a second time window, wherein each graph represents users and items as nodes and user-item interactions within the respective time window as edges, samples user-item node pairs from the second user interaction graph, and trains the heterogeneous GNN based on user-item node pairs from the first user interaction graph that correspond to the sampled user-item node pairs from the second user interaction graph. User and item embeddings generated by the trained GNN may be used to determine a relevancy of a given item with respect to a given user.

### CROSS-REFERENCE TO RELATED APPLICATIONS

This application claims the benefit of U.S. Provisional Patent Application No. 63/459,539, filed Apr. 14, 2023, the contents of which are incorporated herein by reference in its entirety.

### BACKGROUND

### Field

This disclosure is generally directed to computer-implemented retrieval systems, and more particularly to computer-implemented retrieval systems that are designed to identify items of interest to a user based on a query.

### SUMMARY

Provided herein are system, apparatus, article of manufacture, method and/or computer program product embodiments, and/or combinations and sub-combinations thereof, for training a heterogeneous graph neural network (GNN), such as a heterogeneous GraphSAGE neural network, and using the same to generate graph user embeddings that represent users of a retrieval system and graph item embeddings that represent items that may be retrieved by the retrieval system. Such user item embeddings and graph user embeddings may be used, for example, to identify items of interest to a user and/or to rank such items based on relevancy.

In some aspects, training the heterogeneous GNN comprises: generating a first user interaction graph for a first time window, the first user interaction graph representing the users as respective first user nodes, the items as respective first item nodes, and each user-item interaction that occurred during the first time window as a respective first edge connecting a first user node to a first item node; generating a second user interaction graph for a second time window that follows the first time window, the second user interaction graph representing the users as respective second user nodes, the items as respective second item nodes, and each user-item interaction that occurred during the second time window as a respective second edge connecting a second user node to a second item node; sampling second user node and second item node pairs from the second user interaction graph; and training the heterogeneous GNN based on first user node and first item node pairs from the first user interaction graph that respectively correspond to the sampled second user node and second item node pairs from the second user interaction graph.

In some aspects, the first time window and the second time window are overlapping.

In some aspects, sampling the second user node and second item node pairs from the second user interaction graph comprises conducting a predetermined number of walks of a predetermined number of hops from each second user node and second item node in the second user interaction graph and identifying the second user node and second item node pairs based on the walks, wherein: a first hop of a first walk is along a second edge representing a most recent user-item interaction; a first hop of a second walk is along a second edge representing a user-item interaction with a least popular item; a first hop of a third walk is along a second edge representing a user-item interaction with a most popular item; and a first hop of a fourth walk is along a second edge that is selected at random.

In some aspects, generating the first user interaction graph comprises assigning a weight to each first edge of the first user interaction graph, wherein the weight represents a popularity of the item represented by the first item node to which the first edge is connected, and training the heterogeneous GNN comprises minimizing a loss function that incurs a greater penalty for user-item interactions with items having a greater popularity as reflected by the weight.

In some aspects, the items are content items.

In some aspects, the user-item interactions comprises one or more of: a user being shown information about the item; a user interacting with a user interface to obtain information about the item; or a user launching the item for playback.

In some aspects, the trained the trained heterogeneous GNN is used to generate a first graph user embedding corresponding to a first user and a first graph item embedding corresponding to a first item, and a relevancy of the first item to the first user is determined based on the first graph user embedding and the first graph item embedding.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates a block diagram of a personalized retrieval system, according to some embodiments.

FIG. 4 illustrates a block diagram of a heterogeneous graph neural network (GNN) that generates graph user embeddings and graph item embeddings, according to some embodiments.

FIG. 5 illustrates a block diagram of a system for training a heterogeneous GNN and using the same to generate graph user embeddings and graph item embeddings, according to some embodiments.

FIG. 6 is a diagram that illustrates how user-item interactions may be represented in a bipartite graph, according to some embodiments.

FIG. 7 is a diagram that illustrates how user-item interactions that occur during a particular time window may be represented in a bipartite graph, according to some embodiments.

FIGS. 8A, 8B and 8C illustrate various strategies for training a graph neural network, according to some embodiments.

FIG. 9 depicts an example sampling strategy that may be used to generate training data for training a heterogeneous GNN, according to some embodiments

FIG. 10 is a flow diagram of a method for training a heterogeneous GNN to generate graph user embeddings corresponding to users and graph item embeddings corresponding to items, according to some embodiments.

FIG. 11 is a flow diagram of a method for determining a relevancy of a particular item to a particular user, according to some embodiments.

FIG. 12 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Retrieval systems exist that accept a query submitted by a user and then, based on the query, attempt to identify items of interest to the user. For example, some digital media players incorporate a search feature that enables users to submit queries to obtain access to desired media content, such as music, videos, movies, TV programs, or the like. Some conventional retrieval systems are designed to identify items of interest while the user is typing or otherwise inputting a query. For example, after each character of the query is entered, such systems may analyze what the user has input so far—even if it is only one character or a few characters and not a complete word—and attempt to identify items of interest based on the current input. If there are a large number of candidate items to choose from, such systems may not be able to identify relevant items based on only a very small number of input characters. Consequently, such systems may require the user to input a fairly lengthy query before relevant items can be identified. This increases the amount of time and effort it takes for the user to locate items of interest, thus negatively impacting the user experience.

Furthermore, some conventional retrieval systems divide the retrieval process into two stages. First, during a retrieval stage, a set of items deemed relevant to a query is identified. Then, in a ranking stage, a relevancy score is calculated for each item in the set of items and those items are ranked according to their corresponding relevancy scores. Such ranking enables the items to be presented to the user in order of relevancy. In a scenario in which the query comprises only a small number of characters and the inventory of candidate items is very large, the number of items identified in the retrieval stage may also be very large. Consequently, the ranking stage must calculate the relevancy score for a very large number of items, which can be expensive in terms of consumed processor cycles, memory and other computing resources, as well as time-consuming, leading to poor response times for the retrieval system.

Provided herein are system, apparatus, article of manufacture, method and/or computer program product embodiments, and/or combinations and sub-combinations thereof, for training a heterogeneous graph neural network (GNN), such as a heterogeneous GraphSAGE neural network, and using the same to generate graph user embeddings that represent users of a retrieval system and graph item embeddings that represent items that may be retrieved by the retrieval system. Such user item embeddings and graph user embeddings may be used, for example, to identify items of interest to a user and/or to rank such items based on relevancy.

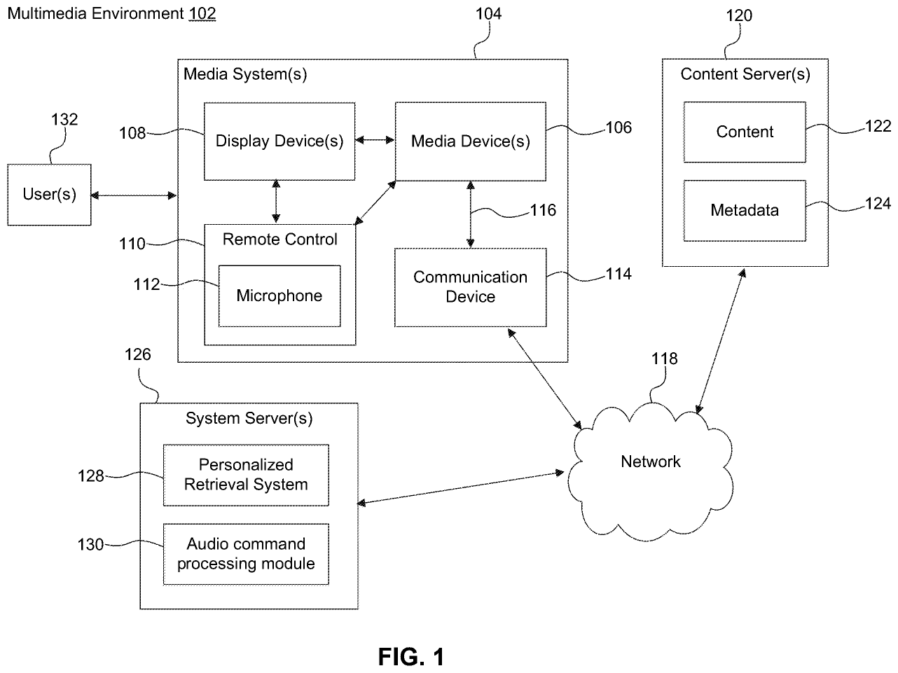

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

Multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some embodiments, media device 106 can be a part of, integrated with, operatively coupled to, and/or connected to its respective display device 108.

Each media device 106 may be configured to communicate with network 118 via a communication device 114. Communication device 114 may include, for example, a cable modem or satellite TV transceiver. Media device 106 may communicate with communication device 114 over a link 116, wherein link 116 may include wireless (such as Wi-Fi) and/or wired connections.

In various embodiments, network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. Remote control 110 can be any component, part, apparatus and/or method for controlling media device 106 and/or display device 108, such as a remote control, a tablet, laptop computer, smartphone, wearable, on-screen controls, integrated control buttons, audio controls, or any combination thereof, to name just a few examples. In an embodiment, remote control 110 wirelessly communicates with media device 106 and/or display device 108 using cellular, Bluetooth, infrared, etc., or any combination thereof. Remote control 110 may include a microphone 112, which is further described below.

Multimedia environment 102 may include a plurality of content servers 120 (also called content providers, channels or sources 120). Although only one content server 120 is shown in FIG. 1, in practice multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to content 122. Metadata 124 may also or alternatively include links to any such information pertaining or relating to content 122. Metadata 124 may also or alternatively include one or more indexes of content 122.

Multimedia environment 102 may include one or more system servers 126. System servers 126 may operate to support media devices 106 from the cloud. It is noted that the structural and functional aspects of system servers 126 may wholly or partially exist in the same or different ones of system servers 126.

System servers 126 may include a personalized retrieval system 128 that enables user 132 to search for and locate items of interest, such as particular content items stored by content servers 120. For example, media device 106 may provide a search interface (e.g., a graphical user interface (GUI)) that is presented to user 132 via display device 108. User 132 may enter a query into the search interface. For example, user 132 may use buttons or other mechanical features of remote control 110 to enter the query, or may speak the query into microphone 112. The query may be transmitted to personalized retrieval system 128 via network 118. Personalized retrieval system 128 may select, based on the query as well as on other information available thereto relating to the user and to the content items, a set of content items that is deemed relevant to the query. Personalized retrieval system 128 may then transmit an identification of the selected content items (e.g., a list of titles and/or other information about the selected content items) to media device 106 for presentation to user 132 via the search interface. The search interface may include controls that a user may interact with to obtain additional information about each content item that is identified and/or to play each content item.

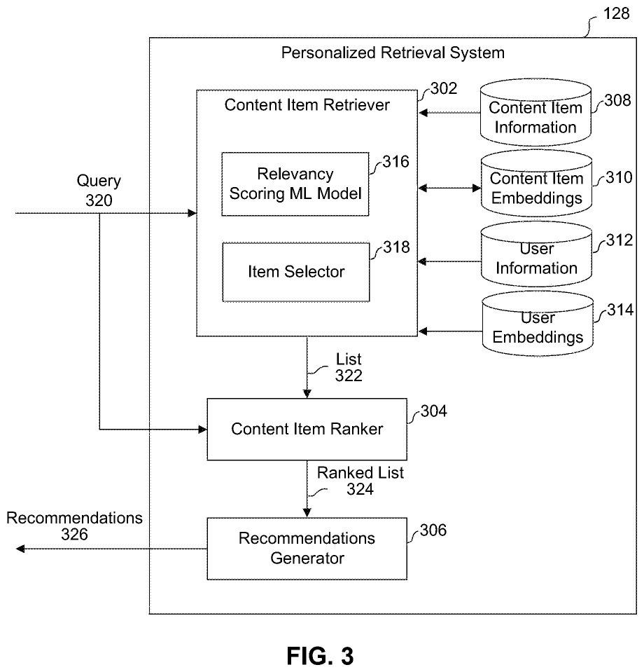

Further details concerning an example implementation of personalized retrieval system 128 will be provided below in reference to FIGS. 3-11.

System servers 126 may also include an audio command processing module 130. As noted above, remote control 110 may include microphone 112. Microphone 112 may receive audio data from users 132 (as well as other sources, such as the display device 108). In some embodiments, media device 106 may be audio responsive, and the audio data may represent verbal commands from user 132 to control media device 106 as well as other components in media system 104, such as display device 108. Also, as noted above, the audio data may comprise a spoken query.

In some embodiments, the audio data received by microphone 112 in remote control 110 is transferred to media device 106, which then forwards the audio data to audio command processing module 130 in system servers 126. Audio command processing module 130 may operate to process and analyze the received audio data to recognize a verbal command of user 132. Audio command processing module 130 may then forward the verbal command back to media device 106 for processing. Audio command processing module 130 may also operate to process and analyze the received audio data to recognize a spoken query of user 132. Audio command processing module 130 may then forward the spoken query to personalized retrieval system 128 for processing.

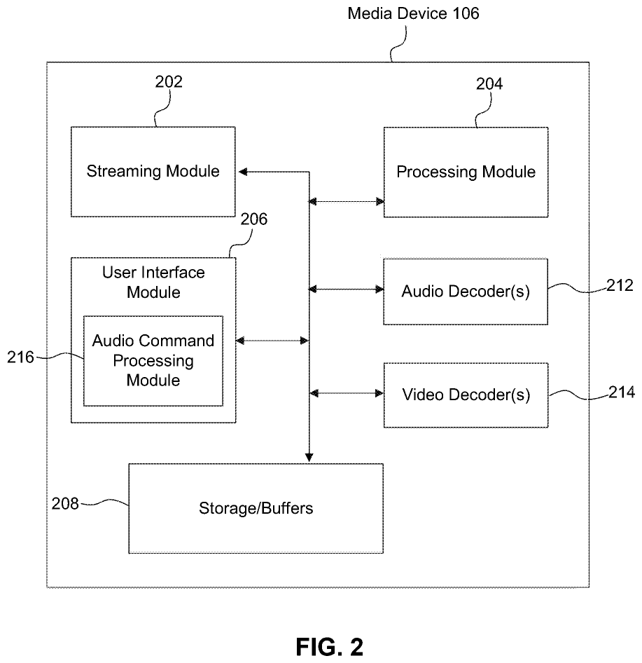

In some embodiments, the audio data may be alternatively or additionally processed and analyzed by an audio command processing module 216 in media device 106 (see FIG. 2). Media device 106 and system servers 126 may then cooperate to pick one of the verbal commands or spoken queries to process (either the verbal command or spoken query recognized by audio command processing module 130 in system servers 126, or the verbal command or spoken query recognized by audio command processing module 216 in media device 106).

FIG. 2 illustrates a block diagram of an example media device 106, according to some embodiments. Media device 106 may include a streaming module 202, a processing module 204, storage/buffers 208, and a user interface module 206. User interface module 206 may be configured to present a search interface associated with personalized retrieval system 128 to user 132 via display device 108. As described above, user interface module 206 may include audio command processing module 216.

Media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OPla, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, user 132 may interact with media device 106 via, for example, remote control 110. For example, user 132 may use remote control 110 to interact with user interface module 206 of media device 106 to select a content item, such as a movie, TV show, music, book, application, game, etc. For example, user 132 may select a content item from among a list of content items generated by personalized retrieval system 128 based on query submitted by user 132. In response to the user selection, streaming module 202 of media device 106 may request the selected content item from content server(s) 120 over network 118. Content server(s) 120 may transmit the requested content item to streaming module 202. Media device 106 may transmit the received content item to display device 108 for playback to user 132.

In streaming embodiments, streaming module 202 may transmit the content item to display device 108 in real time or near real time as it receives such content item from content server(s) 120. In non-streaming embodiments, media device 106 may store the content item received from content server(s) 120 in storage/buffers 208 for later playback on display device 108.

### Personalized Retrieval System

FIG. 3 illustrates a block diagram of personalized retrieval system 128, according to some embodiments. As noted above, personalized retrieval system 128 may be implemented by system server(s) 126 in multimedia environment 102 of FIG. 1. As will be discussed herein, personalized retrieval system 128 may use a two-tower deep ML model to calculate a relevancy score for each of a plurality of candidate content items based on a query. The two-tower deep ML model may comprise a context tower that processes at least user features and query features and an item tower that processes content item features. Personalized retrieval system 128 may select a subset of the candidate content items for retrieval based on the relevancy scores associated therewith and/or rank some or all of the candidate content items based on the relevancy scores associated therewith.

The context tower inputs may include a graph user embedding and the item tower inputs may include a graph item embedding. The graph user embedding may correspond to a user associated with query 320 (e.g., user 132) and may be generated by a heterogeneous graph neural network (GNN) based on at least in part on past interactions between the user and one or more content items. The graph item embedding may correspond to a candidate content item and may also generated by the heterogeneous GNN. As will be discussed herein, the heterogeneous GNN may comprise a hetercogenous GraphSAGE neural network.

As shown in FIG. 3, personalized retrieval system 128 comprises a content item retriever 302, a content item ranker 304, and a recommendations generator 306.

Content item retriever 302 is configured to receive a query 320 submitted by a user and, based at least on query 320, identify one or more content items stored by content servers 120 that are deemed relevant to query 320. As discussed above, user 132 may submit query 320 via a search interface associated with personalized retrieval system 128, wherein the search interface may be rendered to display device 108 by media device 106. Media device 106 may transmit a query to personalized retrieval system 128 each time user 132 enters a new query character into the search interface. Thus, query 320 may consist of a first character of a word or only the first few characters of a word, but not a complete word. However, this is only one example use case, and query 320 may also comprise any combination of words and/or characters.

Content item retriever 302 is configured to receive query 320 and identify a set of content items stored by content servers 120 that are deemed relevant to query 320. Content item retriever 302 is further configured to pass a list 322 that identifies the content items in the set to content item ranker 304. Content item retriever 302 may be configured to limit the size of the set to a predefined number. This may be done, for example, in order to reduce a processing burden on content item ranker 304 and/or improve a response time of personalized retrieval system 128. For example, content item retriever 302 may be configured to cap the size of the set to 100 or 150 content items, although these are merely examples and are by no means limiting.

Content item ranker 304 is configured to receive query 320 and list 322. Content item ranker 304 is further configured to calculate, based at least on query 320, a relevancy score for each content item identified in list 322. Content item ranker 304 is still further configured to generate a ranked list 324 of the content items in which the items are ranked from highest relevancy score to lowest relevancy score, and to pass ranked list 324 to recommendations generator 306.

Recommendations generator 306 is configured to receive ranked list 324 and to generate recommendations 326 based thereon. Recommendations 326 may comprise, for example, information associated with each content item identified in ranked list 324 (e.g., a title of the content item, an icon or image associated with the content item, a content description associated with the content item, a link that activates playback of the content item, or the like). Recommendations generator 306 is further configured to transmit recommendations 326 to media device 106. Media device 106 may present such information to user 132 via a search interface rendered to display device 108. The search interface may enable user 132 to interact with (e.g., click on) a first GUI control associated with each content item included within recommendations 326 to obtain additional information about the corresponding content item and/or a second GUI control associated with each content item included within recommendations 326 to play back (e.g., stream) the corresponding content item.

It is desirable that content item retriever 302 successfully identify the content items that are most relevant to user 132 based on query 320, even if query 320 may consist of only one character or a few characters. This may enable user 132 to more quickly locate and potentially play back a content item of interest, which can greatly improve their user experience as well as conserve system resources (e.g., resources of media device 106 and system servers 126) by avoiding additional searches. Additionally, if content item retriever 302 can consistently identify the most relevant content items, then the cap on the number of content items that are passed from content item retriever 302 to content item ranker 304 can be reduced. Reducing this cap can reduce the processing burden on content item ranker 304, which means that processor cycles, memory and other computing resources of system servers 126 can be conserved. Reducing the processing burden on content item ranker 304 can also improve a response time for personalized retrieval system 128 (e.g., a time between submission of query 320 and the return of recommendations 326).

Precisely identifying content items relevant to a user based on a relatively small number of query characters can be extremely challenging. To address this issue, content item retriever 302 includes a relevancy scoring machine learning (ML) model 316 that accepts as input a number of context features, wherein the context features include query features, user features, and potentially other features relating to the submission of query 320 (e.g., time of day of submission of query 320), and a number of content item features associated with each candidate content item in a plurality of candidate content items, to generate a relevancy score for each candidate content item. Based on the relevancy scores, an item selector 318 selects the highest-scoring candidate content items up to a fixed number of candidate content items and passes an identification of these candidate content items to content item ranker as list 322.

Content item retriever 302 may obtain or derive the user features that are input to relevancy scoring ML model 316 from user information stored in a user information data store 312 and/or from user embeddings stored in a user embeddings data store 314. Content item retriever 302 may be capable of identifying a user associated with query 320 (e.g., user 132) in a variety of ways and then obtain the relevant user information and/or user embeddings associated with the identified user from user information data store 312 and/or user embeddings data store 314. For example, query 320 may be transmitted from media device 106 along with a user identifier (ID), device ID, network address (e.g., IP address) and/or other information that can be used by content item retriever 302 to identify a user associated with query 320.

Content item retriever 302 may obtain or derive the content item features that are input to relevancy scoring ML model 316 from content item information stored in a content item information data store 308 and/or from content item embeddings stored in a content item embeddings data store 310. Content item information data store 308 may comprise metadata 124 as previously described in reference to FIG. 1.

It is noted that in an alternate implementation of personalized retrieval system 128, the process of retrieving relevant content items and then ranking such items may be an integrated process in which various user-related inputs and item-related inputs are processed to retrieve relevant content items in a ranked order. In accordance with such an implementation, content item retriever 302 and content item ranker 304 may be replaced by a single entity that generates a list of relevant content items in a ranked order. Such an implementation may use relevancy scoring ML model 316 to obtain the list of relevant content items in a ranked order.

Relevancy scoring ML model 316 may comprise a two-tower deep ML model that includes a context tower and an item tower. The context tower may accept as input a number of query features, user features, and potentially other features relating to the submission of a query by a user (e.g., a time of day the query was submitted), and processes those features to generate a context embedding (or context vector) in a vector space. The item tower may accept as input a number of item features relating to a candidate content item and processes those features to generate an item embedding (or item vector) in the same vector space. Relevancy scoring ML model 316 may further include an operator that calculates a dot product of the context embedding and the item embedding. The dot product calculated by the operator may be a scalar value that represents a measure of similarity between the context embedding and the item embedding. The dot product calculated by the operator may be used as the relevancy score for the candidate content item represented by the item embedding.

In some aspects, the inputs to the context tower include a graph user embedding and the inputs to the item tower include a graph item embedding. The graph user embedding may correspond to a user associated with query 320 (e.g., user 132) and may be generated by a heterogeneous GNN based on at least in part on past interactions between the user and one or more content items. The graph item embedding may correspond to a candidate content item and may also generated by the heterogeneous GNN. The heterogeneous GNN may be trained on data derived from logs of past interactions between users of personalized retrieval system 128 and content items. Such past interactions may include, for example and without limitation, a user being shown a representation of and/or information about a content item, a user clicking on a GUI control or otherwise interacting with a GUI to obtain information about a content item, or a user playing a content item. The heterogeneous GNN may be capable of learning embeddings for attributes of a graph in which users and content items are represented as nodes and in which relationships between users and content items are represented as edges.

Further information concerning an example implementation of the heterogeneous GNN that produces the aforementioned graph user embedding and graph item embedding will now be provided.

### Heterogeneous Graph Neural Network Using Offset Temporal Learning for Search Personalization

### Personalization

Given a large number of user interaction logs and rich item metadata associated with the content items (e.g. movies and television series), personalized retrieval system 128 may leverage a heterogeneous GNN to address the problem of search personalization. The heterogeneous GNN may comprise, for example and without limitation, a heterogeneous GraphSAGE neural network. One advantage of a GraphSAGE neural network is that it scales to a large corpus of users, items, and their interactions by training the neural network on a subgraph (smaller section of the graph) and then scaling the inference to the entire user interaction graph.

In an example implementation, a heterogeneous graph (i.e., a graph with nodes of different types) of users and items is generated based on a period (e.g., 1 month) of user interaction data, each with their unique features, and then the embedding representations of users and items are jointly learned.

The user nodes in the heterogeneous graph may be represented, for example, by their demographic features. For example, such demographic features may comprise an age and gender feature vector (probability distribution vector) and a country and state feature vector (one hot).

The item nodes in the heterogeneous graph may be represented by, for example, their metadata, learned embeddings and search interaction statistics data. The item metadata may include, for example, release year (e.g., normalized by half-life decay), language of content, and kids appropriate indication. The embedding features may include, for example, TransE_L2 embeddings (e.g., learned on item categories, actors, directors, and Wikipedia keywords), CLIP embeddings (e.g., learned on poster of items), and USE embeddings (e.g., learned on keywords, descriptions, and genres of items). The search interaction statistics may include data about impressions, clicks, launches and normalized streaming hours.

### User Interest Drift

One of the critical challenges with a recommendation/personalization system is that users' taste shifts over time. It can usually be a tremendously challenging task to predict the shift in user interest by relying entirely on the historical interactions of the user. The models that are trained on historical data do a great job of predicting items similar to what the user has historically seen (e.g., if the user saw the Harry Potter series, the static model may identify Narnia as a related item). However, this doesn't guarantee that the user continues to consume related items in the long run.

In view of a complex set of data and overall system complexity, an embodiment may utilize a simple yet elegant sampling strategy to learn temporal shifts that will now be described.

### Conventional Random Walk Sampling

In a conventional GNN, the training data is generated by sampling trajectories using random walk on the current graph. The current graph is then used to train the neural network by leveraging information about every node and their edges. The sampled trajectories are treated as positive samples and a global degree based negative sampling strategy is used to generate the negative samples.

### Random Walk Sampling

In accordance with an implementation, a secondary future graph is generated with interactions data a few days in the future (offset by N days). Positive and negative samples are generated from this secondary future graph (unlike the conventional approach where the current graph is used to generate the training samples). The nodes extracted from the future training data are then used to train the neural network by leveraging information from the current user interaction graph. This process of generating samples from a future distribution while training from current nodes and edges captures temporal information on how current interactions can lead to shifts in future user-item interactions. This can provide a significant lift in prediction performance in downstream tasks (such as personalized retrieval) using this strategy.

### Popularity Debiasing and User Recency

Popularity bias is a common problem in recommendation systems. As a significant number of users interact with popular content, the model often converges to only selecting popular content irrespective of the user's interests and historical behavior. In certain implementations, this issue is addressed by assigning a weight to every user-item interaction that reflects the popularity of the item and adjusting the loss function to penalize popular user-item interactions. A goal here is to capture the niche item watched by the user which carries more information about their preferences than a commonly occurring popular item.

### Custom Loss Function to Debias Popular Items

A custom loss function may be used to debias popular items. For example, a custom loss function to debias popular items may be expressed as:

Loss=ScaledInverseStreamingSecsIn7Days*RepresentationBias*BinaryCrossEntropyLoss,

wherein

ScaledInverseStreamingSecsIn7Day=Alpha*(1−InverseStreamingSecsIn7Days)+1,Alpha=4,

and wherein

InverseStreamingSecsIn7Days can be=1/log(Streaming Hours in 7 Days).

In accordance with this custom loss function, items streamed more overall will receive a lower penalty in loss, as there is less concern about making a mistake for popular items. However, the loss function is specially configured to ensure that niche items for a given user are learned.

In further accordance with such an embodiment, RepresentationBias may be defined as the Popularity Term Frequency Inverse Document Frequency (TFIDF)=Frequency of watching an item*Inverse Document Frequency of the Item,

wherein

Inverse Document Frequency of the Item=log(Popularity of Item).

In accordance with this approach, the more popular the item, the lesser the weight of the interaction and the lesser the penalty.

### Custom Sampling Strategy for Generating Training Data

In order to learn unpopular and most recent items interacted with by a user, an implementation may adopt a custom random walk sampling strategy. For example, in accordance with the custom random walk sampling strategy, the first hop in the first three random walks is not random. Rather, the first hop in the first random walk captures the most recent user-item interaction (e.g., launch), the first hop in the second random walk captures the user-item interaction with the most relevant item to the user (e.g., launched item with highest TF*IDF), and the first hop in the third random walk captures the user-item interaction with the most popular item (e.g., launched item with smallest IDF). The first hop in the fourth random walk is random, to potentially capture other interests.

An example implementation thus provides at least the following innovative features for improving search personalization: transfer learning from upstreamed trained embeddings of items, a custom sampling strategy for capturing temporal user interest shifts, popularity debiasing and recency importance of items to users, and a custom loss function for popularity debiasing of items. Unlike existing approaches, these strategies are relatively simple to implement in a highly complex system. Additionally, the alterations/fine-tuning associated with these strategies are easy to evaluate and customize depending on the data distribution on the platform. Furthermore, this approach is easily scalable to millions of users and items interactions.

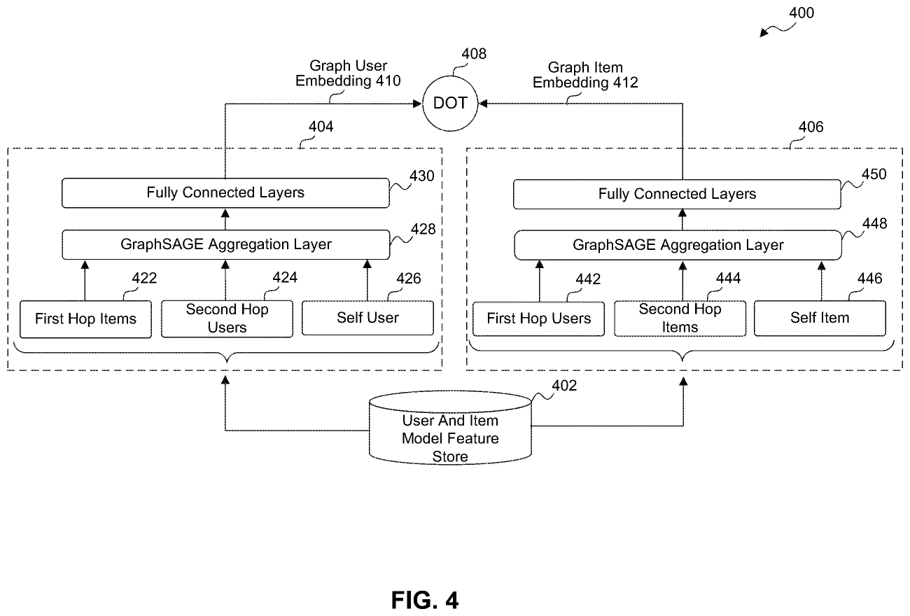

FIG. 4 illustrates a block diagram of a heterogeneous graph neural network (GNN) 400 that generates graph user embeddings and graph item embeddings, according to some embodiments. In the example of FIG. 4, heterogeneous GNN 400 comprises a heterogeneous GraphSAGE neural network. Heterogeneous GNN 400 includes a user tower 404 that is configured to generate a graph user embedding 410, an item tower 406 that is configured to generate a graph item embedding 412, and an operator 408 (“DOT”) that is configured to calculate a dot product between graph user embedding 410 and graph item embedding 412. The dot product calculated by operator 408 may be a scalar value that represents a measure of similarity between graph user embedding 410 and graph item embedding 412.

The inputs to user tower 402 comprise feature information associated with a user (denoted “self user” 426), feature information associated with a sub-sampled set of items that are one hop away from the user in the current user interaction graph (denoted “first hop items” 422), and feature information associated with a sub-sampled set of users that are one hop away from the sub-sampled set of items in the current user interaction graph (denoted “second hop users” 424). These inputs may be obtained from a user and item model feature store 402. These inputs are passed to a GraphSAGE aggregation layer 428 that aggregates the feature information of the second hop users into representations of the first hop items and then aggregates the feature information of the first hop items into a representation of the user in a well-known manner (see, e.g., W. Hamilton, et al., “Inductive Representation Learning on Large Graphs”, 31^{st} Conference on Neural Information Processing Systems (NIPS 2017), Long Beach, CA, USA) The representation of the user output by GraphSAGE aggregation layer 428 is passed to a set of fully connected layers 430 that produces graph user embedding 410 based thereon.

The inputs to item tower 406 comprise feature information associated with an item (denoted “self item” 446), feature information associated with a sub-sampled set of users that are one hop away from the item in the current user interaction graph (denoted “first hop users” 442), and feature information associated with a sub-sampled set of items that are one hop away from the sub-sampled set of users in the current user interaction graph (denoted “second hop items” 444). These inputs may be obtained from user and item model feature store 402. These inputs are passed to a GraphSAGE aggregation layer 448 that aggregates the feature information of the second hop items into representations of the first hop users and then aggregates the feature information of the first hop users into a representation of the item in a well-known manner. The representation of the item output by GraphSAGE aggregation layer 448 is passed to a set of fully connected layers 450 that produces graph item embedding 412 based thereon.

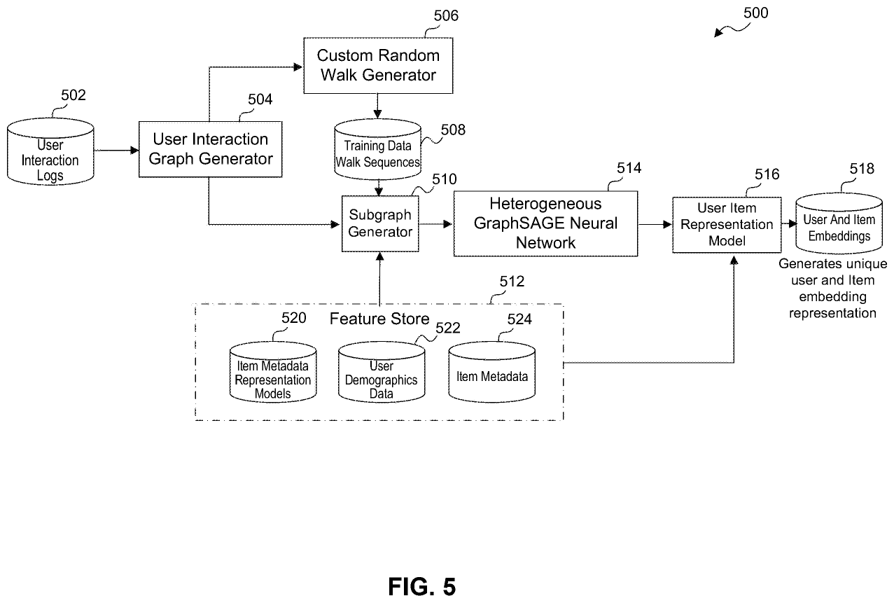

FIG. 5 illustrates a block diagram of a system 500 for training a heterogeneous GNN (e.g. a GraphSAGE neural network) and using the same to generate graph user embeddings and graph item embeddings, according to some embodiments. A user interaction graph generator 504 processes user interaction logs 502 to generate both a current user interaction graph (e.g., a graph generated from user interaction data collected over a first 30 day time window) and a future user interaction graph (e.g., a graph generated from user interaction data collected over a second 30 day time window that is shifted forward N days from the first 30 day time window). In each user interaction graph, users and content items are represented as nodes, and user-item interactions that occurred during the respective time window are represented as edges that connect user nodes to item nodes.

A custom random walk generator 506 then performs a set of walks on each node in the future user interaction graph to generate training data walks sequences 508 from which positive sample user-item pairs are identified for training. Negative sample user-item pairs are also identified from the future user interaction graph for training. A discussion regarding the manner of operation of custom random walk generator 506 is provided elsewhere herein.

A subgraph generator 510 receives the positive sample user-item pairs and negative sample user-item pairs. For each such user-item pair, subgraph generator 510 generates a subgraph to represent the user and a subgraph to represent the item, wherein such subgraphs are generated through subsampling of the one hop nodes and two hop nodes associated with each user/item in the current user interaction graph. In alternate embodiments, a different number of hops (e.g., more than two hops) may be used to generate the subgraphs. Also the number of samples obtained per hop may be a fixed or configurable feature of the network. In one example embodiment, 10 samples are obtained at the first hop and 5 at the second. The features associated with each user and item are obtained from a feature store 512, and such features may include user demographics data 522, item metadata 524, and item metadata representation models 520. Each pair of user and item subgraphs is then passed to a heterogeneous GraphSAGE neural network 514 to train the network. In one implementation, ten training epochs are utilized. A discussion regarding a loss function that may be used to train heterogeneous GraphSAGE neural network 514 is provided elsewhere herein.

Through the aforementioned training of heterogeneous GraphSAGE neural network 514, a trained graph user and item representation model 516 is obtained. Subgraph representations of users and items may be passed to model 516 to obtain corresponding graph user embeddings and graph item embeddings 518.

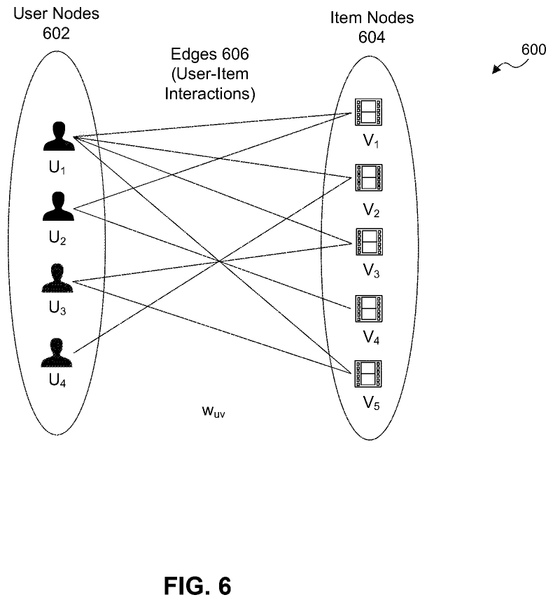

FIG. 6 is a diagram that illustrates how user-item interactions may be represented in a bipartite graph, according to some embodiments. For example, user interaction graph generator 504 may utilize past user-item interactions recorded in user interaction logs 502 to generate a user interaction graph 60 in which users are represented as user nodes 602, content items 604 are represented as item nodes 604, and interactions between users and content items are represented as edges 606 connecting the corresponding user nodes to the corresponding item nodes.

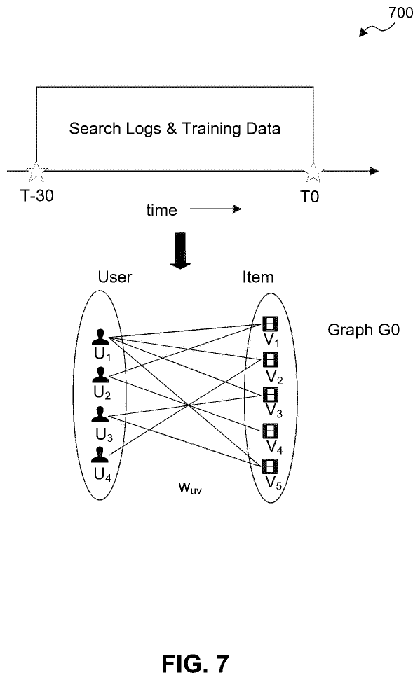

FIG. 7 is a diagram 700 that illustrates how user-item interactions that occur during a particular time window may be represented in a bipartite graph, according to some embodiments. As shown in FIG. 7, user interaction graph generator 504 may utilize user-item interaction data from user interaction logs 502 recorded over a predetermined time period (e.g., 30 days) to generate a user interaction graph G0 in which users are represented as user nodes, content items (e.g., movies and episodes of television series) are represented as item nodes, and interaction between users and content items that took place during the predetermined time period (e.g., user launched content item for playback) are represented as edges connecting the corresponding user nodes to the corresponding item nodes.

In certain implementations, user interaction graph generator 504 may limit the number of edges that may be assigned to a user node to a predetermined number of the most recent item interactions by the corresponding user (e.g., the 10 most recent content item launches by the corresponding user) and may limit the number of interactions per content item to a maximum of one interaction per session. Furthermore, user interaction graph generator 504 may weight each edge in the user interaction graph by the unpopularity of the content item corresponding to the item node to which the edge is connected. For example, a TD*IDF score may be used to weight each edge, where TF (term frequency) in this context is intended to represent the user-specific frequency of launches for the relevant content item, while IDF (inverse document frequency) is intended to represent a global IDF of the relevant content item which is inversely proportional to its popularity.

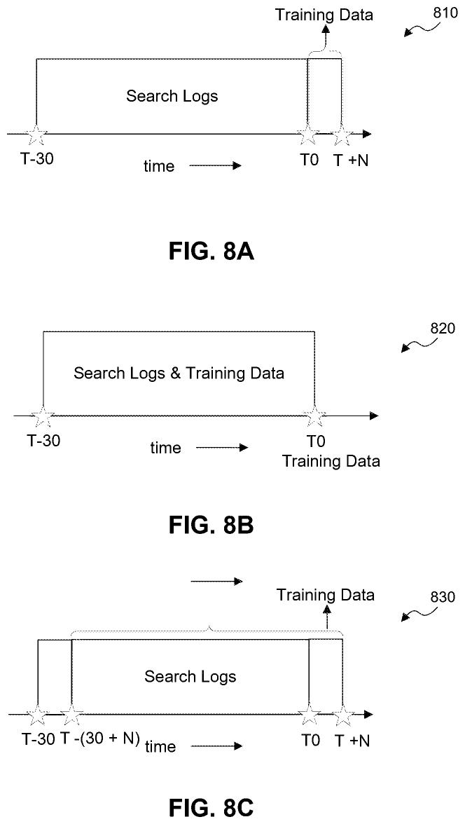

FIGS. 8A, 8B and 8C illustrate various strategies for training a heterogeneous graph neural network, such as a heterogeneous GraphSAGE neural network, in accordance with some embodiments. In particular, FIG. 8A illustrates an example supervised link prediction strategy 810, FIG. 8B illustrates an example unsupervised link prediction strategy 820, and FIG. 8C illustrates an example unsupervised hybrid strategy 830.

In accordance with example supervised link prediction strategy 810, a user interaction graph G0 is generated based on search log data collected during a time window that extends from day T−30 to a day T0. Training data is generated based on search log data collected during a subsequent time window that extends from day T0 to day T+N. The training data is used to train a heterogeneous graph neural network representation of user interaction graph G0 so that it may be used to predict how user interaction graph G0 will evolve over time (e.g., predict what a user will launch on day T1).

In accordance with example unsupervised link prediction strategy 820, a user interaction graph G0 is generated based on search log data collected during a time window that extends from day T−30 to a day T0. Training data is generated by identifying positive sample user-item pairs and negative-sample user item pairs from among the nodes of user interaction graph G0. The training data is used to train a heterogeneous graph neural network representation of user interaction graph G0 so that it can reflect the relationship and structural proximity between user nodes and item nodes.

In accordance with example unsupervised hybrid strategy 830, a user interaction graph G0 is generated based on search log data collected during a first time window that extends from day T−30 to a day T0, and a user interaction graph G1 is generated based on search log data collected during a second, overlapping time window that extends from day T−(30+N) to a day T+N (i.e., the second time window is shifted by N days into the future as compared to the first time window). In this approach, training data is generated by identifying positive sample user-item pairs and negative-sample user item pairs from among the nodes of user interaction graph G1 (unlike the previously-described approach in which G0 is used to generate the training samples). The training data is then applied to train the heterogeneous graph neural network—however, during training, the node representations are generated from the information of user interaction graph G0. This process of identifying training samples from user interaction graph G1 but then training from the corresponding training samples in user interaction graph G0 captures temporal information on how current interactions can lead to shifts in future user-item interactions. This can provide a significant lift in prediction performance in downstream tasks (such as personalized retrieval) using this strategy.

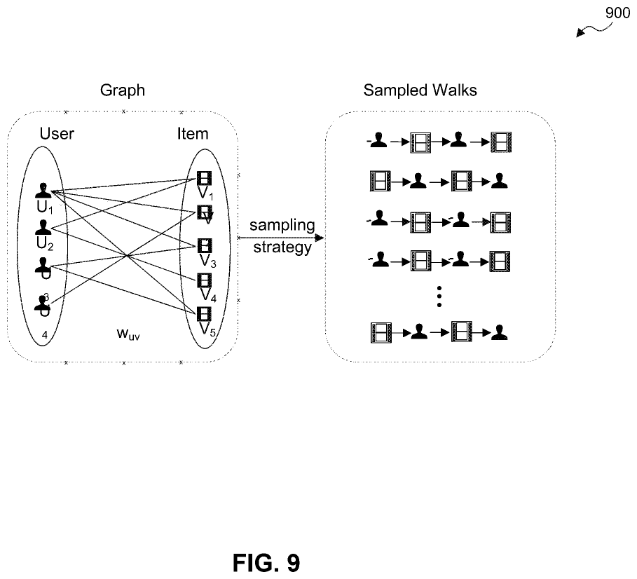

FIG. 9 depicts an example sampling strategy 900 that may be used to generate training data for training a heterogeneous GNN, such as a heterogeneous GraphSAGE neural network, according to some embodiments. For example, training data may be generated by conducting a predefined number of random walks (e.g., 4 random walks) of a predefined length (e.g., 5 hops) from each node in a user interaction graph (e.g., graph G1 as discussed above in reference to FIG. 8C). All user-item pairs identified in a given walk sequence may be identified as positive samples. Global negative samples may also be identified. In certain implementations, a probability distribution that is proportional to popularity may be used for generating negative samples, such that the greater the popularity of an item node the more likely it is to be captured as a negative sample. Item node degree may be used as an indicator of item popularity in this context. This can help to debias popular items in the graph user and item representation model.

For example, custom random walk generator 506 may utilize a custom random walk sampling strategy to facilitate learning of unpopular and most recent items interacted with by a user. In one particular example, the first hop in the first three random walks is not random. Rather, the first hop in the first random walk captures the most recent user-item interaction (e.g., launch), the first hop in the second random walk captures the user-item interaction with the most relevant item to the user (e.g., launched item with highest TF*IDF), and the first hop in the third random walk captures the user-item interaction with the most popular item (e.g., launched item with smallest IDF). However, the first hop in the fourth random walk may be random, to potentially capture other interests. Further, the second hop in all the random walks may be random.

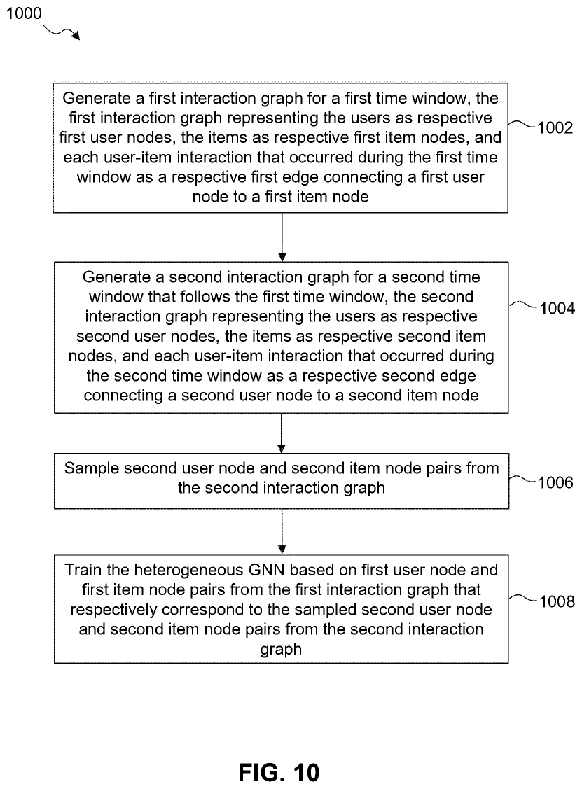

FIG. 10 is a flow diagram of a method 1000 for training a heterogeneous GNN to generate graph user embeddings corresponding to users and graph item embeddings corresponding to items (e.g. content items), according to some embodiments. Method 1000 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 10, as will be understood by a person of ordinary skill in the art.

Method 1000 shall be described with reference to FIG. 5. However, method 1000 is not limited to that example embodiment.

In 1002, user interaction graph generator 504 generates a first user interaction graph for a first time window (e.g., user interaction graph G0, as discussed above in reference to FIG. 8C), the first user interaction graph representing the users as respective first user nodes, the items as respective first item nodes, and each user-item interaction that occurred during the first time window as a respective first edge connecting a first user node to a first item node. The user-item interactions may comprise, for example and without limitation, one or more of a user being shown information about the item, a user interacting with a user interface to obtain information about the item, or a user launching the item for playback.

In 1004, user interaction graph generator 504 generates a second user interaction graph for a second time window that follows the first time window (e.g., user interaction graph G1 as discussed above in reference to FIG. 8C), the second user interaction graph representing the users as respective second user nodes, the items as respective second item nodes, and each user-item interaction that occurred during the second time window as a respective second edge connecting a second user node to a second item node. In certain implementations, the first time window and the second time window may be overlapping.

In 1006, custom random walk generator 506 samples second user node and second item node pairs from the second interaction graph. For example, custom random walk generator 506 may perform a set of walks on each node in the second user interaction graph to generate training data walks sequences from which positive second user node and second item node pairs may be sampled. In 1006, negative second user node and second item node pairs may also be sampled from the second user interaction graph.

In certain implementations, sampling the second user node and second item node pairs from the second user interaction graph comprises conducting a predetermined number of walks of a predetermined number of hops from each second user node and second item node in the second user interaction graph and identifying the second user node and second item node pairs based on the walks. In further accordance with such an implementation, a first hop of a first walk may be along a second edge representing a most recent user-item interaction, a first hop of a second walk may be along a second edge representing a user-item interaction with a least popular item, a first hop of a third walk may be along a second edge representing a user-item interaction with a most popular item, and a first hop of a fourth walk may be along a second edge that is selected at random.

In 1008, the heterogeneous GNN is trained based on first user node and first item node pairs from the first interaction graph that respectively correspond to the sampled second user node and second item node pairs from the second interaction graph. The heterogeneous GNN may comprise, for example and without limitation, a heterogeneous GraphSAGE neural network.

As discussed elsewhere herein, subgraph generator 510 may receive the sampled second user node and second item node pairs from the second user interaction graph and, for each such pair, generate a subgraph that represents the user corresponding to the second user node and a subgraph that represents the item corresponding to the the second item node. Each pair of subgraphs may then be passed to a heterogeneous GraphSAGE neural network 514 to train the network. The trained heterogeneous GNN may comprise user item representation model 516.

In certain implementations, generating the first user interaction graph in 1002 comprises assigning a weight to each first edge of the first user interaction graph, wherein the weight represents a popularity of the item represented by the first item node to which the first edge is connected, and training the heterogeneous GNN in 1008 comprises minimizing a loss function that incurs a greater penalty for user-item interactions with items having a greater popularity as reflected by the weight.

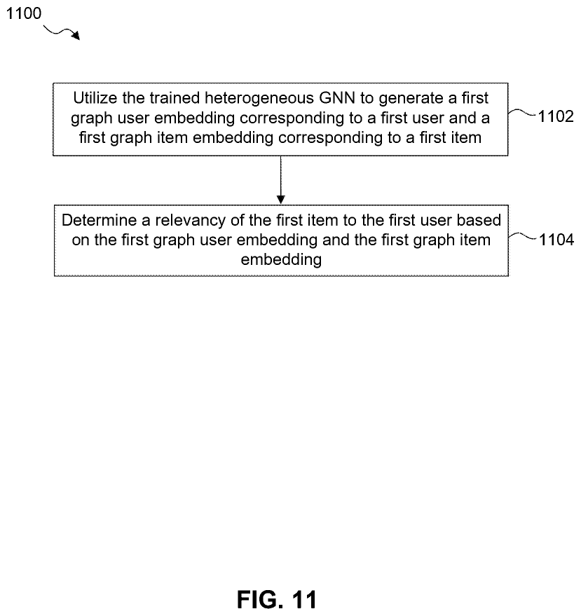

FIG. 11 is a flow diagram of a method 1100 for determining a relevancy of a particular item to a particular user, according to some embodiments. Method 1100 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 11, as will be understood by a person of ordinary skill in the art.

Method 1100 shall be described with reference to FIGS. 3 and 5. However, method 1100 is not limited to those example embodiments.

In 1102, the trained heterogeneous GNN (e.g., user item representation model 516) is utilized to generate a first graph user embedding corresponding to a first user and a first graph item embedding corresponding to a first item. As noted elsewhere herein, a subgraph representation of the first user may be passed to user item representation model 516 to generate the first graph user embedding, and a subgraph representation of the first item may be passed to user item representation model 516 to generate the first graph item embedding.

In 1104, content item retriever 302 of personalized retrieval system 128 determines a relevancy of the first item to the first user based on the first graph user embedding and the first graph item embedding. For example, as discussed elsewhere herein, content item retriever 302 may pass the first graph user embedding to a context tower of relevancy scoring ML model 316 (along with other inputs discussed herein) and pass the first graph item embedding to an item tower of relevancy scoring ML model 316 (along with other inptus discussed herein), and based thereon, relevancy scoring ML model 316 may determine a relevancy score for the first item with respect to the first user.

### Example Computer System

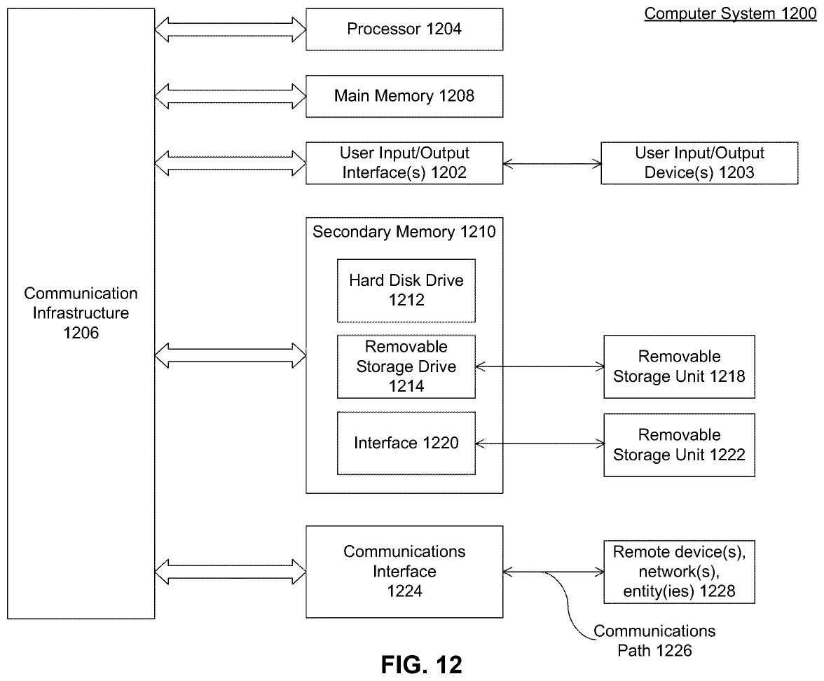

Various embodiments may be implemented, for example, using one or more well-known computer systems, such as computer system 1200 shown in FIG. 12. For example, one or more of media device 106, remote control 110, content servers 120, system servers 126, personalized retrieval system 128, relevancy scoring ML model 316, heterogeneous GNN 400, or system 500 may be implemented using combinations or sub-combinations of computer system 1200. Also or alternatively, one or more computer systems 1200 may be used, for example, to implement any of the embodiments discussed herein, as well as combinations and sub-combinations thereof.

Computer system 1200 may include one or more processors (also called central processing units, or CPUs), such as a processor 1204. Processor 1204 may be connected to a communication infrastructure or bus 1206.

Computer system 1200 may also include user input/output device(s) 1203, such as monitors, keyboards, pointing devices, etc., which may communicate with communication infrastructure 1206 through user input/output interface(s) 1202.

One or more of processors 1204 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1200 may also include a main or primary memory 1208, such as random access memory (RAM). Main memory 1208 may include one or more levels of cache. Main memory 1208 may have stored therein control logic (i.e., computer software) and/or data.

Computer system 1200 may also include one or more secondary storage devices or memory 1210. Secondary memory 1210 may include, for example, a hard disk drive 1212 and/or a removable storage device or drive 1214. Removable storage drive 1214 may be a floppy disk drive, a magnetic tape drive, a compact disk drive, an optical storage device, tape backup device, and/or any other storage device/drive.

Removable storage drive 1214 may interact with a removable storage unit 1218. Removable storage unit 1218 may include a computer usable or readable storage device having stored thereon computer software (control logic) and/or data. Removable storage unit 1218 may be a floppy disk, magnetic tape, compact disk, DVD, optical storage disk, and/any other computer data storage device. Removable storage drive 1214 may read from and/or write to removable storage unit 1218.

Secondary memory 1210 may include other means, devices, components, instrumentalities or other approaches for allowing computer programs and/or other instructions and/or data to be accessed by computer system 1200. Such means, devices, components, instrumentalities or other approaches may include, for example, a removable storage unit 1222 and an interface 1220. Examples of the removable storage unit 1222 and the interface 1220 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1200 may further include a communication or network interface 1224. Communication interface 1224 may enable computer system 1200 to communicate and interact with any combination of external devices, external networks, external entities, etc. (individually and collectively referenced by reference number 1228). For example, communication interface 1224 may allow computer system 1200 to communicate with external or remote devices 1228 over communications path 1226, which may be wired and/or wireless (or a combination thereof), and which may include any combination of LANs, WANs, the Internet, etc. Control logic and/or data may be transmitted to and from computer system 1200 via communication path 1226.

Computer system 1200 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1200 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1200 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1200, main memory 1208, secondary memory 1210, and removable storage units 1218 and 1222, as well as tangible articles of manufacture embodying any combination of the foregoing. Such control logic, when executed by one or more data processing devices (such as computer system 1200 or processor(s) 1204), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 12. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for training a heterogeneous graph neural network (GNN) to generate graph user embeddings corresponding to users and graph item embeddings corresponding to items, comprising:
generating, by at least one computer processor, a first user interaction graph for a first time window, the first user interaction graph representing the users as respective first user nodes, the items as respective first item nodes, and each user-item interaction that occurred during the first time window as a respective first edge connecting a first user node to a first item node;
generating a second user interaction graph for a second time window that follows the first time window, the second user interaction graph representing the users as respective second user nodes, the items as respective second item nodes, and each user-item interaction that occurred during the second time window as a respective second edge connecting a second user node to a second item node;
sampling second user node and second item node pairs from the second user interaction graph; and
training the heterogeneous GNN based on first user node and first item node pairs from the first user interaction graph that respectively correspond to the sampled second user node and second item node pairs from the second user interaction graph.

2. The computer-implemented method of claim 1, further comprising:
utilizing the trained heterogeneous GNN to generate a first graph user embedding corresponding to a first user and a first graph item embedding corresponding to a first item; and
determining a relevancy of the first item to the first user based on the first graph user embedding and the first graph item embedding.

3. The computer-implemented method of claim 1, wherein the first time window and the second time window are overlapping.

4. The computer-implemented method of claim 1, wherein sampling the second user node and second item node pairs from the second user interaction graph comprises:
conducting a predetermined number of walks of a predetermined number of hops from each second user node and second item node in the second user interaction graph and identifying the second user node and second item node pairs based on the walks, wherein:
a first hop of a first walk is along a second edge representing a most recent user-item interaction;
a first hop of a second walk is along a second edge representing a user-item interaction with a least popular item;
a first hop of a third walk is along a second edge representing a user-item interaction with a most popular item; and
a first hop of a fourth walk is along a second edge that is selected at random.

5. The computer-implemented method of claim 1, wherein:
generating the first user interaction graph comprises assigning a weight to each first edge of the first user interaction graph, wherein the weight represents a popularity of the item represented by the first item node to which the first edge is connected; and
training the heterogeneous GNN comprises minimizing a loss function that incurs a greater penalty for user-item interactions with items having a greater popularity as reflected by the weight.

6. The computer-implemented method of claim 1, wherein the heterogeneous GNN comprises a heterogeneous GraphSAGE neural network.

7. The computer-implemented method of claim 1, wherein the user-item interactions comprises one or more of:
a user being shown information about the item;
a user interacting with a user interface to obtain information about the item; or
a user launching the item for playback.

8. A system for training a heterogeneous graph neural network (GNN) to generate graph user embeddings corresponding to users and graph item embeddings corresponding to items, comprising:
one or more memories;
at least one processor each coupled to at least one of the memories and configured to perform operations comprising:
generating a first user interaction graph for a first time window, the first user interaction graph representing the users as respective first user nodes, the items as respective first item nodes, and each user-item interaction that occurred during the first time window as a respective first edge connecting a first user node to a first item node;
generating a second user interaction graph for a second time window that follows the first time window, the second user interaction graph representing the users as respective second user nodes, the items as respective second item nodes, and each user-item interaction that occurred during the second time window as a respective second edge connecting a second user node to a second item node;
sampling second user node and second item node pairs from the second user interaction graph; and
training the heterogeneous GNN based on first user node and first item node pairs from the first user interaction graph that respectively correspond to the sampled second user node and second item node pairs from the second user interaction graph.

9. The system of claim 8, wherein the operations further comprise:
utilizing the trained heterogeneous GNN to generate a first graph user embedding corresponding to a first user and a first graph item embedding corresponding to a first item; and
determining a relevancy of the first item to the first user based on the first graph user embedding and the first graph item embedding.

10. The system of claim 8, wherein the first time window and the second time window are overlapping.

11. The system of claim 8, wherein sampling the second user node and second item node pairs from the second user interaction graph comprises:
conducting a predetermined number of walks of a predetermined number of hops from each second user node and second item node in the second user interaction graph and identifying the second user node and second item node pairs based on the walks, wherein:
a first hop of a first walk is along a second edge representing a most recent user-item interaction;
a first hop of a second walk is along a second edge representing a user-item interaction with a least popular item;
a first hop of a third walk is along a second edge representing a user-item interaction with a most popular item; and
a first hop of a fourth walk is along a second edge that is selected at random.

12. The system of claim 8, wherein:
generating the first user interaction graph comprises assigning a weight to each first edge of the first user interaction graph, wherein the weight represents a popularity of the item represented by the first item node to which the first edge is connected; and
training the heterogeneous GNN comprises minimizing a loss function that incurs a greater penalty for user-item interactions with items having a greater popularity as reflected by the weight.

13. The system of claim 8, wherein the GNN comprises a heterogeneous GraphSAGE neural network.

14. The system of claim 8, wherein the user-item interactions comprises one or more of:
a user being shown information about the item;
a user interacting with a user interface to obtain information about the item; or
a user launching the item for playback.

15. A non-transitory computer-readable medium having instructions stored thereon that, when executed by at least one computing device, cause the at least one computing device to perform operations for training a heterogeneous graph neural network (GNN) to generate graph user embeddings corresponding to users and graph item embeddings corresponding to items, the operations comprising:
generating a first user interaction graph for a first time window, the first user interaction graph representing the users as respective first user nodes, the items as respective first item nodes, and each user-item interaction that occurred during the first time window as a respective first edge connecting a first user node to a first item node;
generating a second user interaction graph for a second time window that follows the first time window, the second user interaction graph representing the users as respective second user nodes, the items as respective second item nodes, and each user-item interaction that occurred during the second time window as a respective edge connecting a second user node to a second item node;
sampling second user node and second item node pairs from the second user interaction graph; and
training the heterogeneous GNN based on first user node and second item node pairs from the first user interaction graph that correspond to the sampled second user node and second item node pairs from the second user interaction graph.

16. The non-transitory computer-readable medium of claim 15, wherein the operations further comprise:
utilizing the trained heterogeneous GNN to generate a first graph user embedding corresponding to a first user and a first graph item embedding corresponding to a first item; and
determining a relevancy of the first item to the first user based on the first graph user embedding and the first graph item embedding.

17. The non-transitory computer-readable medium of claim 15, wherein the first time window and the second time window are overlapping.

18. The non-transitory computer-readable medium of claim 15, wherein sampling the second user node and second item node pairs from the second user interaction graph comprises:
conducting a predetermined number of walks of a predetermined number of hops from each second user node and second item node in the second user interaction graph and identifying the second user node and second item node pairs based on the walks, wherein:
a first hop of a first walk is along a second edge representing a most recent user-item interaction;
a first hop of a second walk is along a second edge representing a user-item interaction with a least popular item;
a first hop of a third walk is along a second edge representing a user-item interaction with a most popular item; and
a first hop of a fourth walk is along a second edge that is selected at random.

19. The non-transitory computer-readable medium of claim 15, wherein:
generating the first user interaction graph comprises assigning a weight to each first edge of the first user interaction graph, wherein the weight represents a popularity of the item represented by the first item node to which the edge is connected; and
training the heterogeneous GNN comprises minimizing a loss function that incurs a greater penalty for user-item interactions with items having a greater popularity as reflected by the weight.

20. The non-transitory computer-readable medium of claim 15, wherein the user-item interactions comprises one or more of:
a user being shown information about the item;
a user interacting with a user interface to obtain information about the item; or
a user launching the item for playback.
